(19) United States
(12) Patent Application Publication
(10) Pub. No.: US 2026/0166714 A1
(43) Pub. Date: Jun. 18, 2026

(54) GRIPPER OF ROBOT

(71) Applicants: HYUNDAI MOTOR COMPANY, Seoul (KR); Kia Corporation, Seoul (KR)

(72) Inventors: Sangmin JUNG, Hwaseong-si (KR); Taeheun JIN, Hwaseong-si (KR)

(21) Appl. No.: 19/205,282

(22) Filed: May 12, 2025

(30) Foreign Application Priority Data
Dec. 16, 2024 (KR) 10-2024-0186756

(51) Int. Cl. B25J 9/00; B25J 11/00; B25J 15/06; B25J 19/00

(52) U.S. Cl. CPC B25J 9/0009; B25J 11/005; B25J 15/0608; B25J 19/0025

(57) ABSTRACT

A gripper of the robot includes a first gripper disposed at a base bracket and configured to move in a first direction, a second gripper disposed at the base bracket and configured to rotate in a second direction, and a third gripper disposed at the base bracket and configured to rotate in the second direction. The third gripper is configured to face the second gripper.

### CROSS-REFERENCE TO RELATED APPLICATION

This application claims priority to and the benefit of Korean Patent Application No. 10-2024-0186756, filed at the Korean Intellectual Property Office, on Dec. 16, 2024, the entire contents of which are incorporated herein by reference.

### TECHNICAL FIELD

The present disclosure relates to a gripper of a robot. More specifically, the present disclosure relates to a gripper of a robot capable of loading and unloading parts using magnetic force.

### BACKGROUND

Various automated processes are adopted and applied in the vehicle manufacturing process. For example, the automated process may be used to grip parts, move the parts to a target location, and unload them using robots.

In some cases, in order to grip parts of various sizes and shapes, robots corresponding to parts of different sizes and shapes may be used. In some cases, using a plurality of robots to grip parts of various sizes and shapes may increase installation costs and occupy a space for the automated process.

### SUMMARY

The present disclosure describes a gripper apparatus of a robot configured to grip parts of various sizes and shapes and unload the parts at a target location.

According to one aspect of the subject matter described in this application, a gripper apparatus for vehicle manufacturing includes a base bracket, a first gripper disposed at the base bracket and configured to move in a first direction, the first gripper being configured to grip a part of a vehicle, a second gripper disposed at the base bracket and configured to rotate in a second direction, the second gripper being configured to grip the part, and a third gripper that is disposed at the base bracket and configured to rotate in the second direction, the third gripper being configured to grip the part. The third gripper is configured to face the second gripper.

Implementations according to this aspect can include one or more of the following features. For example, the first gripper can include a first main bracket coupled to the base bracket, a first gripping portion disposed at the first main bracket and configured to selectively grip the part by magnetic force, and a first floating portion configured to provide elastic force between the first main bracket and the first gripping portion and configured to support the first gripping portion to move in the first direction.

In some implementations, the first floating portion can include a first floating bracket configured to support the first gripping portion, and a first elastomer configured to provide elastic force between the first main bracket and the first floating bracket in the first direction. In some examples, the first gripping portion can include a first magnetic force generator configured to generate magnetic force, a first pneumatic generator configured to generate pneumatic pressure and configured to move the first magnetic force generator, and a first clamping portion configured to grip the part by the magnetic force generated by the first magnetic force generator. For example, the first pneumatic generator can include a first piston and a first solenoid configured to operate the first piston.

In some implementations, the second gripper can include a second main bracket disposed at the base bracket, a second gripping portion disposed at the second main bracket and configured to selectively grip the part by magnetic force, and a second floating portion configured to provide elastic force between the second main bracket and the second gripping portion and configured to support the second gripping portion to move in a third direction orthogonal to the first and second directions.

In some implementations, the second floating portion can include a second floating bracket configured to support the second gripping portion and hinge-connected to the second main bracket, and a plurality of elastomers configured to provide elastic force between the second main bracket and the second floating bracket. For example, the plurality of elastomers can include two elastomers arranged in the first direction.

In some implementations, the second gripping portion can include a second magnetic force generator configured to generate magnetic force, a second pneumatic generator configured to generate pneumatic pressure and configured to move the second magnetic force generator, and a second clamping portion configured to grip the part by the magnetic force generated by the second magnetic force generator. In some examples, the second pneumatic generator can include a second piston and a second solenoid configured to operate the second piston.

In some implementations, the third gripper can include a third main bracket disposed at the base bracket, a third gripping portion disposed at the third main bracket and configured to selectively grip the part by magnetic force, and a third floating portion configured to provide elastic force between the third main bracket and the third gripping portion and configured to support the third gripping portion to move in a third direction orthogonal to the first and second directions. In some examples, the third floating portion can include a third floating bracket configured to support the third gripping portion and hinge-connected to the third main bracket, and a plurality of elastomers configured to provide elastic force between the third main bracket and the third floating bracket. For instance, the plurality of elastomers can include two elastomers arranged in the first direction.

In some implementations, the third gripping portion can include a third magnetic force generator configured to generate magnetic force, a third pneumatic generator configured to generate pneumatic pressure to move the third magnetic force generator, and a third clamping portion configured to grip the part by the magnetic force generated by the third magnetic force generator. In some examples, the third pneumatic generator can include a third piston and a third solenoid configured to operate the third piston.

In some implementations, the second gripper and the third gripper are disposed symmetrically with respect to the first gripper. In some implementations, the first gripper, the second gripper, and the third gripper are configured to define a triangle on a plane perpendicular to the first direction.

In some implementations, it can be possible to accurately grip a curved and complexly shaped part by a plurality of floating portions.

In some implementations, it can be possible to actively correct the position of the part when gripping the part.

### BRIEF DESCRIPTION OF THE DRAWINGS

Since these drawings are for reference in describing example implementations of the present disclosure, the technical ideas of the present disclosure should not be construed as limited to the attached drawings.

FIG. 1 is a conceptual diagram illustrating an example configuration of a robot system to which a gripper apparatus is applied.

FIG. 2 is a block diagram illustrating an example configuration of the robot system.

FIG. 3 is a perspective view illustrating an example configuration of the gripper apparatus.

FIGS. 4, 5A, and 5B are perspective views illustrating example components of the gripper apparatus.

FIGS. 6 and 7 are perspective views illustrating an example configuration of a first gripper of the gripper apparatus.

FIGS. 8 and 9 are perspective views illustrating an example configuration of a second gripper of the gripper apparatus.

FIGS. 10 and 11 are perspective views illustrating an example configuration of a third gripper of the gripper apparatus.

FIG. 12 is a flowchart for describing an example operation of the gripper apparatus.

### DETAILED DESCRIPTION

Hereinafter, a gripper apparatus for vehicle manufacturing is described in detail with reference to the attached drawings.

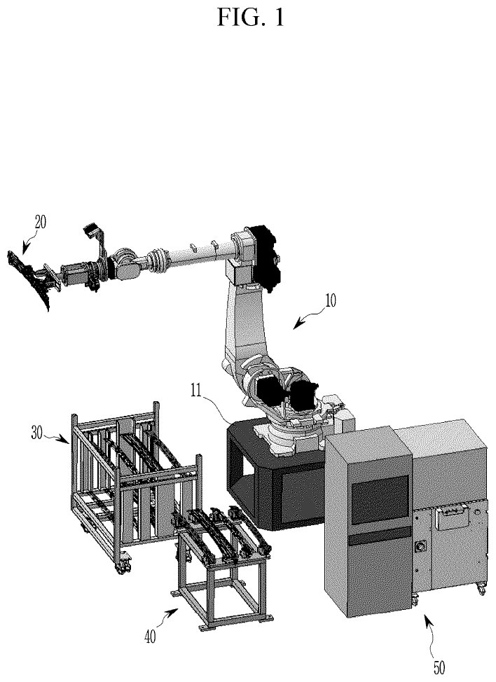

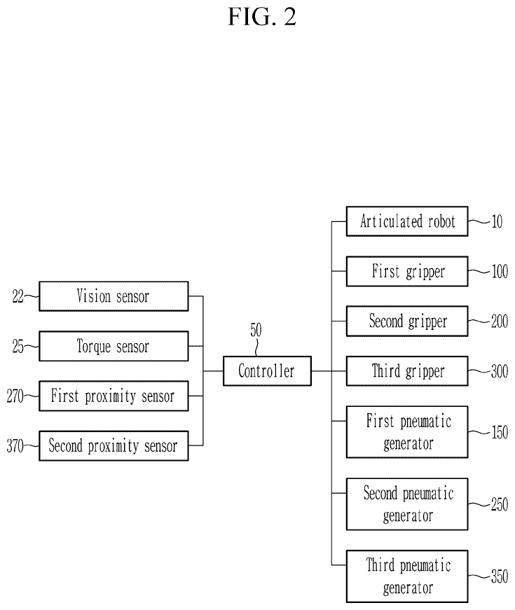

FIG. 1 is a conceptual diagram illustrating an example configuration of a robot system including a gripper apparatus. FIG. 2 is a block diagram illustrating an example configuration of the robot system.

In some implementations, referring to FIGS. 1 and 2, a robot system can include a gripper apparatus 20, a pallet 30 on which a part is loaded, a loading jig 40 for placing the part, an articulated robot 10 for loading the part loaded on the pallet 30 and unloading the part into the loading jig 40, and a controller 50 for controlling the articulated robot 10.

In some examples, the articulated robot 10 can be implemented through a six-axis articulated robot 10 capable of moving in the x-axis, y-axis, and z-axis directions of the robot based on a base frame 11 and rotating in the Rx-axis, Ry-axis, and Rz-axis directions.

In some implementations, the gripper apparatus 20 can be configured to selectively grip the part and be provided at the end of the articulated robot 10. The gripper apparatus 20 of the robot can be configured to unload the part from the pallet 30 in one direction (e.g., vertical direction) and load the part into the loading jig 40 in one direction (e.g., vertical direction).

In some implementations, the direction (e.g., vertical direction) in which the gripper apparatus 20 of the articulated robot 10 grips and loads the part from the pallet 30 and the direction (e.g., vertical direction) in which the articulated robot 10 unloads the part into the loading jig 40 can be the same.

In some implementations, the articulated robot 10 is can include various sensors, where the controller 50 can control the articulated robot 10 and the gripper apparatus 20 of the robot mounted on the articulated robot 10 based on information detected by the sensors. The controller 50 can include a robot controller 50 and a vision controller 50. The robot controller 50 and the vision controller 50 can be integrated into one controller 50.

In some examples, the controller 50 can include an electric circuit, a computer, a processor, or a pneumatic controller. For instance, the controller 50 can be implemented with one or more processors that operate by a predetermined program, and a memory of the controller 50 stores program instructions programmed to perform each step of a control method of the articulated robot 10 including the gripper apparatus 20 of the robot according to the present disclosure through one or more processors.

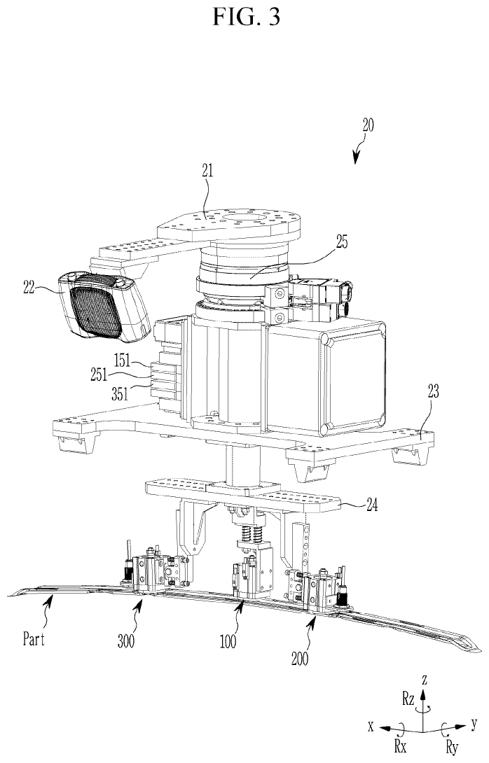

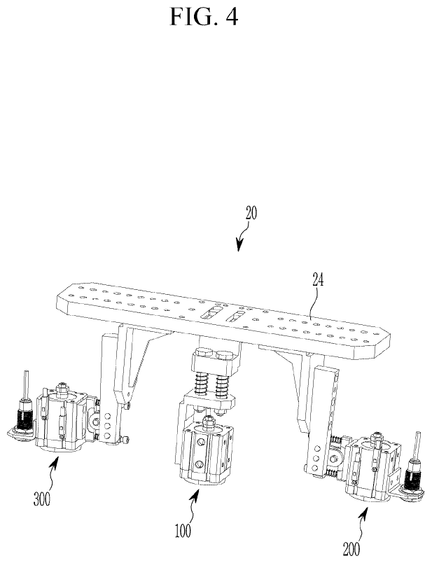

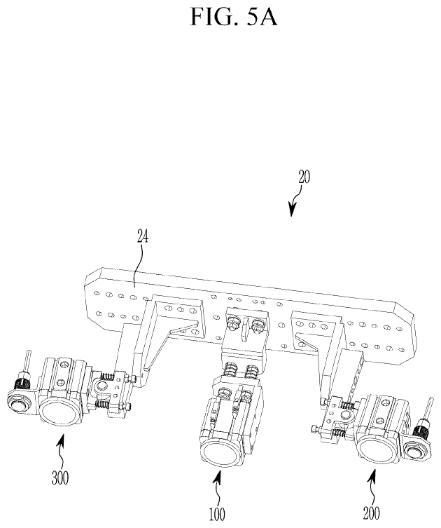

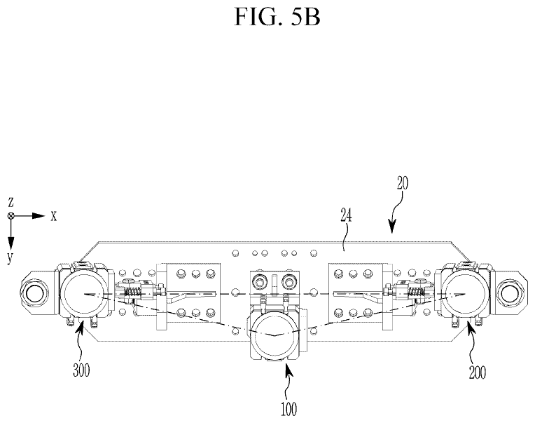

FIG. 3 is a perspective view illustrating an example configuration of the gripper apparatus. FIGS. 4, 5A, and 5B are perspective views illustrating example components of the gripper apparatus.

As shown in FIGS. 3 to 5B, the gripper apparatus 20 of the robot can include an installation bracket 21 mounted on an end of the articulated robot 10, a plurality of sensors installed on the installation bracket 21, a mounting bracket 23 installed on a lower portion of the installation bracket 21, a base bracket 24 installed on a lower portion of the mounting bracket 23, and a first gripper 100 to a third gripper 300 on which the base bracket 24 is installed.

The plurality of sensors can include a vision sensor 22 installed on the installation bracket 21 and a torque sensor 25 installed on the installation bracket 21.

The vision sensor 22 can capture an image of the surroundings of the gripper apparatus 20 of the robot, and the image captured by the vision sensor 22 can be transmitted to the controller 50. The vision sensor 22 can be implemented as a 3-dimensional structured light sensor capable of capturing a wide area at a fast-scanning speed.

The controller 50 determines the position (e.g., x-axis, y-axis, z-axis, Rx, Ry, Rz position) of the articulated robot 10 based on the image captured by the vision sensor 22, and can control the articulated robot 10 based on the determined position of the articulated robot 10. In other words, the controller 50 can control the articulated robot 10 to be transferred to the pallet 30 loaded with the part, control the articulated robot 10 to load the part from the pallet 30 through the gripper apparatus 20 of the robot, control the part loaded into the articulated robot 10 to be transferred to the loading jig 40, and control the part loaded into the articulated robot 10 to be unloaded onto the loading jig 40.

The torque sensor 25 can measure the torque (or force) transmitted to the gripper apparatus 20 of the robot, and the torque (or force) measured by the torque sensor 25 can be transmitted to the controller 50. The controller 50 can stably grip the part based on the torque measured by the torque sensor 25.

In some examples, the gripper apparatus 20 of the robot can include the first gripper 100, a second gripper 200, and a third gripper 300 capable of gripping the part by magnetic force.

The first gripper 100, the second gripper 200, and the third gripper 300 can be installed on the base bracket 24. The second gripper 200 and the third gripper 300 can be disposed symmetrically with respect to the first gripper 100.

The first gripper 100 can be provided to be movable in a first direction (e.g., the z-axis direction) set to grip the part. The second gripper 200 can be provided to be rotatable in a second direction (e.g., Rx direction) set to grip the part. The third gripper 300 can be provided to be rotatable in the second direction (e.g., Rx direction) set to grip the part. That is, the second gripper 200 and the second gripper 200 are configured to rotate about the X-axis extending in the Rx direction. The third gripper 300 can be disposed to face the second gripper 200.

In some implementations, the first gripper 100, the second gripper 200, and the third gripper 300 can be disposed to form a triangle with respect to a plane perpendicular to the first direction (e.g., the z-axis direction). For example, the first gripper 100, the second gripper 200, and the third gripper 300 are disposed to define a triangle on the x-y plane, thereby stably gripping the part.

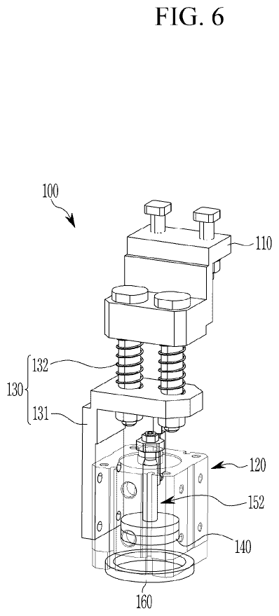

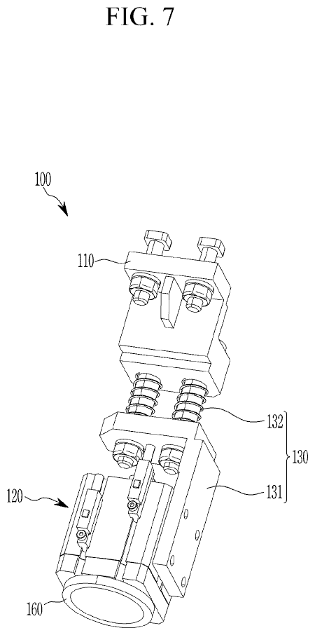

Referring to FIGS. 6 and 7, the first gripper 100 can include a first main bracket 110, a first gripping portion 120, and a first floating portion 130.

The first main bracket 110 is mounted on the lower portion of the base bracket 24, and the first gripping portion 120 can be mounted on the first main bracket 110. The first gripping portion 120 can selectively grip the part by magnetic force.

The first floating portion 130 can be installed between the first main bracket 110 and the first gripping portion 120. The first floating portion 130 can provide elastic force between the first main bracket 110 and the first gripping portion 120 so that the first gripping portion 120 floats in the first direction.

In some implementations, the first floating portion 130 can include a first floating bracket 131 and a first elastomer 132.

The first floating bracket 131 supports the first gripping portion 120 and can be formed in a roughly inverted “L” shape. That is, the first gripping portion 120 is affixed to the first floating bracket 131 so that the first floating bracket 131 and the first gripping portion 120 can float as one unit.

The first elastomer 132 can provide elastic force between the first main bracket 110 and the first floating bracket 131 in the first direction. For this purpose, the first elastomer 132 can be implemented as a compression coil spring. In some examples, the first elastomers 132 can be provided in a pair, and the pair of first elastomers 132 can be disposed parallel to the first direction.

The first gripping portion 120 can include a first magnetic force generator 140, a first pneumatic generator 150, and a first clamping portion 160.

The first magnetic force generator 140 can generate magnetic force to grip the part. For example, the first magnetic force generator 140 can be implemented as a neodymium magnet. The magnetic force generated by the first magnetic force generator 140 is applied to the part through the first clamping portion 160, and accordingly, the first gripping portion 120 can grip the part.

The first pneumatic generator 150 can generate pneumatic pressure to move the first magnetic force generator 140 in a predetermined direction (e.g., vertical direction with respect to the drawing). For example, the first pneumatic generator 150 can include a first solenoid 151 and a first piston 152 operated by the first solenoid 151. When the first solenoid 151 operates, pneumatic pressure is generated inside the first gripping portion 120, allowing the first piston 152 to move downward. As the first piston 152 moves downward, the first magnetic force generator 140 provided on the lower portion of the first piston 152 can move downward.

When the first magnetic force generator 140 moves downward and the first magnetic force generator 140 approaches the part, the magnetic force of the first magnetic force generator 140 is applied to the part through the first clamping portion 160, and accordingly, the first gripping portion 120 can firmly grip the part.

In some cases, if no pneumatic pressure is generated by the first pneumatic generator 150, the first piston 152 and the first magnetic force generator 140 move upward, and the first magnetic force generator 140 moves away from the part. Accordingly, the part that was gripped by the first clamping portion 160 can be released from the first clamping portion 160.

The first clamping portion 160 can be in close contact with the part. The first clamping portion 160 can be formed of a flexible material having an adhesive force, such as rubber. Since the first clamping portion 160 is formed of a flexible material, when the first clamping portion 160 is in close contact with the part, the part can be prevented from being scratched or damaged.

When the part approaches the first magnetic force generator 140, a metallic part can be attracted to the first gripping portion 120 by magnetic force, and the part can be loaded. In this case, the part can be prevented from being damaged or scratched by the first clamping portion 160 made of a flexible material.

When the part moves away from the first magnetic force generator 140, the part attracted to the first gripping portion 120 can be separated from the first gripping portion 120 and the part can be unloaded.

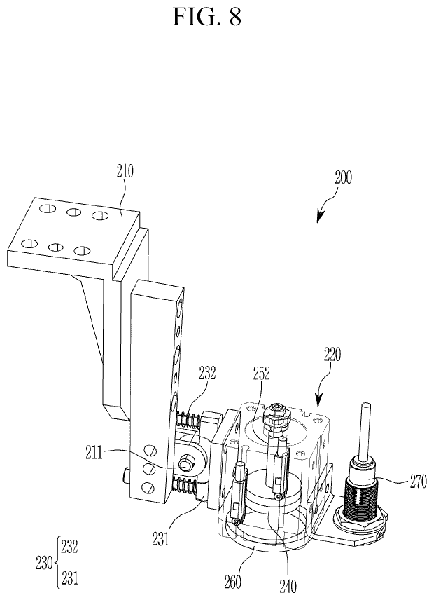

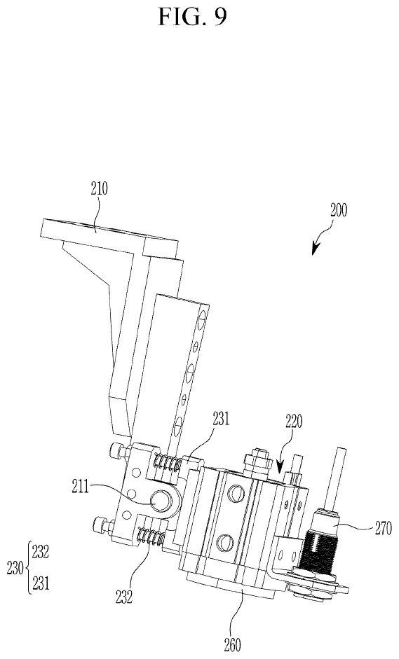

Referring to FIGS. 8 and 9, the second gripper 200 can include a second main bracket 210, a second gripping portion 220, and a second floating portion 230.

The second main bracket 210 can be mounted on the lower portion of the base bracket 24, and the second gripping portion 220 can be mounted on the second main bracket 210. The second gripping portion 220 can selectively grip the part by magnetic force.

The second floating portion 230 can be installed between the second main bracket 210 and the second gripping portion 220. The second floating portion 230 can provide elastic force between the second main bracket 210 and the second gripping portion 220 so that the second gripping portion 220 floats in the second direction.

In some implementations, the second floating portion 230 can include a second floating bracket 231 and a second elastomer 232.

The second floating bracket 231 can support the second gripping portion 220. That is, the second gripping portion 220 is affixed to the second floating bracket 231 so that the second floating bracket 231 and the second gripping portion 220 can float as one unit.

The second floating bracket 231 can be hinge-connected to the second main bracket 210. For example, the second floating bracket 231 can be hinge-connected through a hinge axis 211 provided on the second main bracket 210. Accordingly, the second floating bracket 231 and the second gripping portion 220 can be rotated in the second direction (Rx direction).

The second elastomer 232 can provide elastic force in the second direction (Rx direction) between the second main bracket 210 and the second floating bracket 231. In some implementations, a pair of second elastomers 232 can be disposed in the first direction (x-axis direction) centered on the hinge axis 211 between the second main bracket 210 and the second floating bracket 231. The second elastomer 232 can be implemented as a compression coil spring. By positioning the second elastomer 232 above and below the hinge axis 211, the second floating bracket 231 and the second gripping portion 220 can rotate in the second direction (Rx direction) with respect to the second main bracket 210. For example, the pair of second elastomers 232 can be configured to be compressed and extended by different displacements and to support the second gripping portion 220 to rotate about the x-axis. That is, the pair of second elastomers 232 can be configured to move in the y-direction relative to each other.

The second gripping portion 220 can include a second magnetic force generator 240, a second pneumatic generator 250, and a second clamping portion 260.

The second magnetic force generator 240 can generate magnetic force to grip the part. In some implementations, the second magnetic force generator 240 can be implemented as a neodymium magnet. The magnetic force generated by the second magnetic force generator 240 is applied to the part through the second clamping portion 260, and accordingly, the second gripping portion 220 can grip the part.

The second pneumatic generator 250 can generate pneumatic pressure to move the second magnetic force generator 240 in a predetermined direction (e.g., vertical direction with respect to the drawing). In some implementations, the second pneumatic generator 250 can include a second solenoid 251 and a second piston 252 operated by the second solenoid 251. When the second solenoid 251 is actuated, pneumatic pressure is generated inside the second gripping portion 220, allowing the second piston 252 to move downward. As the second piston 252 moves downward, the second magnetic force generator 240 provided at the lower portion of the second piston 252 can move downward.

When the second magnetic force generator 240 moves downward and the second magnetic force generator 240 approaches the part, the magnetic force of the second magnetic force generator 240 is applied to the part through the second clamping portion 260, and accordingly, the second gripping portion 220 can firmly grip the part.

In some cases, if no pneumatic pressure is generated by the first pneumatic generator 150, the first piston 152 and the first magnetic force generator 140 move upward, and the first magnetic force generator 140 moves away from the part. Accordingly, the part that was gripped by the second clamping portion 260 can be released from the second clamping portion 260.

The second clamping portion 260 can be in close contact with the part. The second clamping portion 260 can be formed of a flexible material having an adhesive force, such as rubber. Since the second clamping portion 260 is formed of a flexible material, when the second clamping portion 260 is in close contact with the part, the part can be prevented from being scratched or damaged.

When the part approaches the second magnetic force generator 240, a metallic part can be attracted to the second gripping portion 220 by magnetic force, and the part can be loaded. In this case, the part can be prevented from being damaged or scratched by the second clamping portion 260 formed of a flexible material.

When the part moves away from the second magnetic force generator 240, the part attracted by the second gripping portion 220 can be separated from the second gripping portion 220 and the part can be unloaded.

In some examples, the second gripping portion 220 can be equipped with a first proximity sensor 270. The first proximity sensor 270 can measure the distance to the part, and the measured distance to the part can be transmitted to the controller 50. The first proximity sensor 270 can determine whether the part has been gripped.

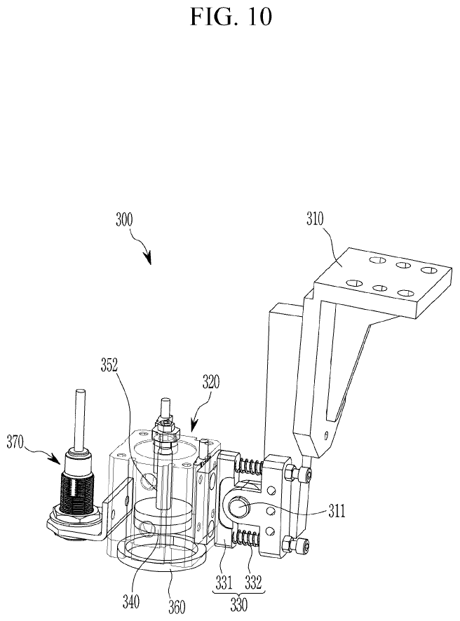

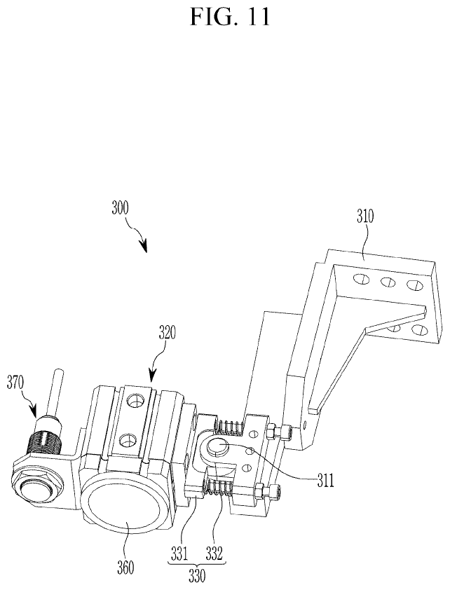

Referring to FIGS. 10 and 11, the third gripper 300 can include a third main bracket 310, a third gripping portion 320, and a third floating portion 330.

The third main bracket 310 can be mounted on the lower portion of the base bracket 24, and the third gripping portion 320 can be mounted on the third main bracket 310. The third gripping portion 320 can selectively grip the part by magnetic force.

The third floating portion 330 can be installed between the third main bracket 310 and the third gripping portion 320. The third floating portion 330 can provide elastic force between the third main bracket 310 and the third gripping portion 320 so that the third gripping portion 320 floats in the second direction.

In some implementations, the third floating portion 330 can include a third floating bracket 331 and a third elastomer 332.

The third floating bracket 331 can support the third gripping portion 320. That is, the third gripping portion 320 is affixed to the third floating bracket 331 so that the third floating bracket 331 and the third gripping portion 320 can float as one unit.

The third floating bracket 331 can be hinge-connected to the third main bracket 310. For example, the third floating bracket 331 can be hinge-connected through a hinge axis 311 provided on the third main bracket 310. Accordingly, the third floating bracket 331 and the third gripping portion 320 can be rotated in the second direction (Rx direction).

The third elastomer 332 can provide elastic force in the second direction (Rx direction) between the third main bracket 310 and the third floating bracket 331. In some implementations, a pair of third elastomers 332 can be disposed in the first direction (x-axis direction) centered on the hinge axis 311 between the third main bracket 310 and the third floating bracket 331. The third elastomer 332 can be implemented as a compression coil spring. By positioning the third elastomer 332 above and below the hinge axis 311, the third floating bracket 331 and the third gripping portion 320 can float in the second direction (Rx direction) with respect to the third main bracket 310.

For example, the pair of third elastomers 332 can be configured to be compressed and extended by different displacements and to support the third gripping portion 320 to rotate about the x-axis. That is, the pair of third elastomers 332 can be configured to move in the y-direction relative to each other.

The third gripping portion 320 can include a third magnetic force generator 340, a third pneumatic generator 350, and a third clamping portion 360.

The third magnetic force generator 340 can generate magnetic force to grip the part. In some implementations, the third magnetic force generator 340 can be implemented as a neodymium magnet. The magnetic force generated by the third magnetic force generator 340 is applied to the part through the third clamping portion 360, and accordingly, the third gripping portion 320 can grip the part.

The third pneumatic generator 350 can generate pneumatic pressure to move the third magnetic force generator 340 in a predetermined direction (e.g., vertical direction with respect to the drawing). In some implementations, the third pneumatic generator 350 can include a third solenoid 351 and a third piston 352 operated by the third solenoid 351. When the third solenoid 351 operates, pneumatic pressure is generated inside the third gripping portion 320, allowing the third piston 352 to move downward. As the third piston 352 moves downward, the third magnetic force generator 340 provided at the lower portion of the third piston 352 can move downward.

When the second magnetic force generator 240 moves downward and the second magnetic force generator 240 approaches the part, the magnetic force of the second magnetic force generator 240 is applied to the part through a third clamping portion 360, and accordingly, the third gripping portion 320 can firmly grip the part.

In some cases, if no pneumatic pressure is generated by the third pneumatic generator 350, the third piston 352 and the third magnetic force generator 340 move upward, and the third magnetic force generator 340 moves away from the part. Accordingly, the part that was gripped by the third clamping portion 360 can be released from the third clamping portion 360.

The third clamping portion 360 can be in close contact with the part. The third clamping portion 360 can be formed of a flexible material having an adhesive force, such as rubber. Since the third clamping portion 360 is formed of a flexible material, when the third clamping portion 360 is in close contact with the part, the part can be prevented from being scratched or damaged.

When the part approaches the third magnetic force generator 340, a metallic part can be attracted to the third gripping portion 320 by magnetic force, and the part can be loaded. In this case, the part can be prevented from being damaged or scratched by the third clamping portion 360 made of a flexible material.

When the part moves away from the third magnetic force generator 340, the part attracted to the third gripping portion 320 can be separated from the third gripping portion 320 and the part can be unloaded.

In some examples, the third gripping portion 320 can be equipped with a second proximity sensor 370. The second proximity sensor 370 can measure the distance to the part, and the measured distance to the part can be transmitted to the controller 50. The second proximity sensor 370 can determine whether the part has been gripped.

Hereinafter, the operation of the robot system including the gripper apparatus 20 of the robot will be described in detail with reference to the attached drawings.

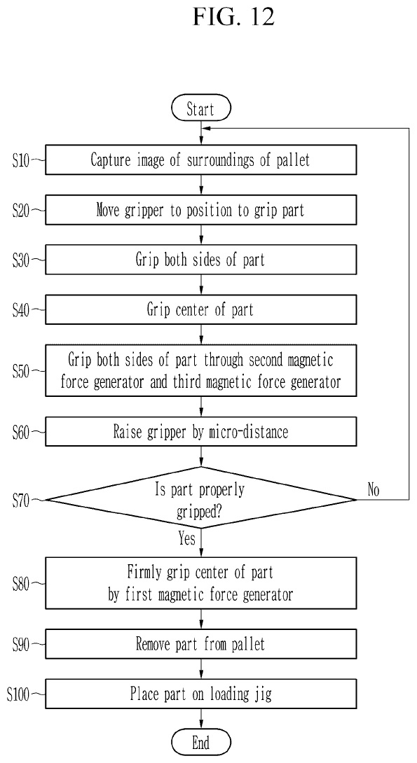

FIG. 12 is a flowchart for describing the operation of the gripper apparatus 20 of the robot.

Referring to FIG. 12, the controller 50 can move the articulated robot 10 to the pallet 30 loaded with the part, and the vision sensor 22 can capture an image of the surroundings of the pallet 30 and transmit the image to the controller 50 (S10). The controller 50 can determine the 3-dimensional coordinates of the part through the image captured by the vision sensor 22.

The controller 50 can move the gripper apparatus 20 of the articulated robot 10 to a position to grip the part through the determined 3-dimensional coordinates (S20). In this case, the gripper apparatus 20 of the articulated robot 10 can be positioned on the upper portion of the part to be gripped.

The controller 50 can grip both sides of the part through the second gripper 200 and the third gripper 300 (S30). The controller 50 can control the gripper apparatus 20 of the articulated robot 10 to move closer to the part, and accordingly, both sides of the part can be gripped by the second clamping portion 260 of the second gripper 200 and the third clamping portion 360 of the third gripper 300. In this case, even if there is an error in the coordinates of the part determined by the vision sensor 22, since the second floating portion 230 and the third floating portion 330 float in the second direction (Rx direction), the part can be accurately gripped according to the curvature profile and shape of the part.

The controller 50 can grip the center of the part through the first gripper 100 (S40). With both sides of the part gripped by the second clamping portion 260 and the third clamping portion 360, the controller 50 controls the gripper apparatus 20 of the articulated robot 10 to move closer to the part, and accordingly, the center of the part can be gripped by the first clamping portion 160 of the first gripper 100. In this case, even if there is an error in the coordinates of the part determined through the vision sensor 22, since the first floating portion 130 floats in the first direction (z-axis direction), the part can be accurately gripped according to the z-axis direction shape of the part.

The controller 50 can firmly grip both sides of the part through the second magnetic force generator 240 and the third magnetic force generator 340 (S50). The controller 50 can operate the second pneumatic generator 250 and the third pneumatic generator 350 to bring the second magnetic force generator 240 and the third magnetic force generator 340 closer to the part.

Accordingly, the second gripping portion 220 and the third gripping portion 320 can firmly grip both sides of the part by the magnetic force generated by the second magnetic force generator 240 and the third magnetic force generator 340.

With both sides of the part gripped by the magnetic force of the second magnetic force generator 240 and the third magnetic force generator 340, the controller 50 can control the articulated robot 10 to raise the gripper apparatus 20 of the robot in the upward direction (z-axis direction) by a predetermined distance (for example, 20 to 30 mm) (S60). In this case, only the second pneumatic generator 250 and the third pneumatic generator 350 are operated to grip both sides of the part through the second magnetic force generator 240 and the third magnetic force generator 340 to prevent two or more parts from being gripped.

The controller 50 can determine, through the proximity sensors 270 and 370, whether the gripper apparatus 20 of the robot has properly gripped the part (S70).

If it is determined that the part has not been properly gripped, there is a possibility that the part can fall from the gripper apparatus 20 of the robot during the process of removing the part from the pallet 30 and transferring it to the loading jig 40. To prevent this, the controller 50 can stop the operation of the second pneumatic generator 250 and the third pneumatic generator 350, and move to step S10 to re-perform the step of gripping the part.

If it is determined that the part has been properly gripped, the center of the part can be gripped through the first gripper 100 (S80). In this case, the controller 50 can operate the first pneumatic generator 150 to bring the first magnetic force generator 140 closer to the part. Accordingly, the first gripping portion 120 can firmly grip the center of the part by the magnetic force generated by the first magnetic force generator 140.

In step S80, when the part is firmly gripped by the first gripping portion 120 to the third gripping portion 320, the controller 50 controls the articulated robot 10 to raise the gripper apparatus 20 of the robot in the upward direction (z-axis direction), thereby removing the part from the pallet 30 (S90).

After the part is removed from the pallet 30, the controller 50 can control the articulated robot 10 to position the gripper apparatus 20 of the robot to the upper portion of the loading jig 40, and control the first gripper 100 to the third gripper 300 to place the part on the loading jig 40 (S100).

In some implementations, the gripper apparatus 20 of the robot and the robot system including the same have a plurality of floating portions to accurately grip curved and complexly shaped parts.

Further, when gripping the part, it is possible to actively correct the position of the part using the magnetic force generator and the pneumatic generator, which increases the degree of freedom for gripping the part and makes it easier to standardize the gripper apparatus 20 of the robot.

While this disclosure has been described in connection with what is presently considered to be practical implementations, it is to be understood that the disclosure is not limited to the disclosed implementations, but, is intended to cover various modifications and equivalent arrangements included within the spirit and scope of the appended claims.

What is claimed is:

1. A gripper apparatus for vehicle manufacturing, the gripper apparatus comprising:
a base bracket;
a first gripper disposed at the base bracket and configured to move in a first direction, the first gripper being configured to grip a part of a vehicle;
a second gripper disposed at the base bracket and configured to rotate in a second direction, the second gripper being configured to grip the part; and
a third gripper that is disposed at the base bracket and configured to rotate in the second direction, the third gripper being configured to grip the part,
wherein the third gripper is configured to face the second gripper.

2. The gripper apparatus of claim 1, wherein the first gripper comprises:
a first main bracket coupled to the base bracket;
a first gripping portion disposed at the first main bracket and configured to selectively grip the part by magnetic force; and
a first floating portion configured to provide elastic force between the first main bracket and the first gripping portion and configured to support the first gripping portion to move in the first direction.

3. The gripper apparatus of claim 2, wherein the first floating portion comprises:
a first floating bracket configured to support the first gripping portion; and
a first elastomer configured to provide elastic force between the first main bracket and the first floating bracket in the first direction.

4. The gripper apparatus of claim 2, wherein the first gripping portion comprises:
a first magnetic force generator configured to generate magnetic force;
a first pneumatic generator configured to generate pneumatic pressure and configured to move the first magnetic force generator; and
a first clamping portion configured to grip the part by the magnetic force generated by the first magnetic force generator.

5. The gripper apparatus of claim 4, wherein the first pneumatic generator comprises:
a first piston; and
a first solenoid configured to operate the first piston.

6. The gripper apparatus of claim 1, wherein the second gripper comprises:
a second main bracket disposed at the base bracket;
a second gripping portion disposed at the second main bracket and configured to selectively grip the part by magnetic force; and
a second floating portion configured to provide elastic force between the second main bracket and the second gripping portion and configured to support the second gripping portion to rotate in the second direction.

7. The gripper apparatus of claim 6, wherein the second floating portion comprises:
a second floating bracket configured to support the second gripping portion and hinge-connected to the second main bracket; and
a plurality of elastomers configured to provide elastic force between the second main bracket and the second floating bracket.

8. The gripper apparatus of claim 7, wherein the plurality of elastomers can include two elastomers arranged in the first direction.

9. The gripper apparatus of claim 6, wherein the second gripping portion comprises:
a second magnetic force generator configured to generate magnetic force;
a second pneumatic generator configured to generate pneumatic pressure and configured to move the second magnetic force generator; and
a second clamping portion configured to grip the part by the magnetic force generated by the second magnetic force generator.

10. The gripper apparatus of claim 9, wherein the second pneumatic generator comprises:
a second piston; and
a second solenoid configured to operate the second piston.

11. The gripper apparatus of claim 1, wherein the third gripper comprises:
a third main bracket disposed at the base bracket;
a third gripping portion disposed at the third main bracket and configured to selectively grip the part by magnetic force; and
a third floating portion configured to provide elastic force between the third main bracket and the third gripping portion and configured to support the third gripping portion to rotate in the second direction.

12. The gripper apparatus of claim 11, wherein the third floating portion comprises:
a third floating bracket configured to support the third gripping portion and hinge-connected to the third main bracket; and
a plurality of elastomers configured to provide elastic force between the third main bracket and the third floating bracket.

13. The gripper apparatus of claim 12, wherein the plurality of elastomers can include two elastomers arranged in the first direction.

14. The gripper apparatus of claim 11, wherein the third gripping portion comprises:
a third magnetic force generator configured to generate magnetic force;
a third pneumatic generator configured to generate pneumatic pressure to move the third magnetic force generator; and
a third clamping portion configured to grip the part by the magnetic force generated by the third magnetic force generator.

15. The gripper apparatus of claim 14, wherein the third pneumatic generator comprises:
a third piston; and
a third solenoid configured to operate the third piston.

16. The gripper apparatus of claim 1, wherein the second gripper and the third gripper are disposed symmetrically with respect to the first gripper.

17. The gripper apparatus of claim 1, wherein the first gripper, the second gripper, and the third gripper are configured to define a triangle on a plane perpendicular to the first direction.
